(19) United States
(12) Patent Application Publication
(10) Pub. No.: US 2007/0113997 A1
(43) Pub. Date: May 24, 2007

(54) Thickener for paper coating compositions

(76) Inventor: Detlev Glittenberg, Krefeld (DE)

Correspondence Address: FISH & RICHARDSON P.C., PO BOX 1022, MINNEAPOLIS, MN, 55440-1022, US

(21) Appl. No.: 10/580,937

(22) PCT Filed: Nov. 26, 2004
(86) PCT No.: PCT/EP04/13433

§ 371 Date: May 30, 2006

(30) Foreign Application Priority Data
Nov. 27, 2003 (EP) 03257477.4

(51) Int. Cl. C09J 103/06; D21H 17/00

(52) U.S. Cl. 162/175; 106/207.1

(57) ABSTRACT

A paper coating composition comprising one or more thickeners, characterised in that at least one of said one or more thickeners is a cold water swellable starch ester, methods of preparing such compositions and their use in coating paper products.

### TECHNICAL FIELD

The present invention relates to paper coating compositions comprising a starch-based thickener, to paper products coated with such compositions and to methods of preparing such compositions and products.

### BACKGROUND OF THE INVENTION

Coating compositions have been developed that can contribute, amongst other things, to improved appearance and feel (e.g. improved gloss, slickness, brilliance, and colour), improved printability (e.g. smear-resistance, ink-absorption and adhesion) and improved strength. The ingredients included in such compositions can be divided into three main categories: pigments, binders and thickeners.

Thickeners, in particular, have to be chosen very carefully as they are responsible for determining the coating composition's Theological properties. It will have to be ensured, for example, that at low shear the coating composition has a low enough viscosity for easy pumping but a high enough viscosity to maintain a homogeneous suspension and to prevent excessive absorption into the paper. At high shear (for example during blade application of the composition), the viscosity will have to be low enough to ensure that an even coating of the composition can be applied over the entire surface of the paper without having to apply too high a blade pressure to obtain the desired coat weight. In addition, the coating composition should have good water retention values and torque properties and should be stable during storage and at the high temperatures required for drying. To meet all of these requirements, a number of different thickeners have been proposed.

To date, the most commonly used thickeners have included cellulose ethers such as carboxymethyl cellulose (CMC), modified starches and synthetic products such as water-soluble polymers. Unfortunately, none of these products have proved to be entirely satisfactory.

Cellulose ethers suitable for use as thickeners tend to be obtainable only by relatively complex preparation methods. This is a disincentive in itself but also means that such products carry a prohibitively high price tag. What is more, it has often been found that cellulose ether-based compositions do not have good stability (in terms of viscosity) at high shear or at high temperature. Although some synthetic polymers have been developed to replace cellulose ethers, these do not tend to have comparable thickening properties, for example in terms of water retention.

Similarly, although some starch thickeners have been suggested (including, in particular, cold water soluble starches obtained e.g. by roll drying of native or chemically modified starches), these do not provide the necessary viscosity to the coating compositions at typical thickener addition levels, i.e. generally less than 2 parts per 100 parts pigment. Higher addition levels of such starches become uneconomic and furthermore can impair desired properties of the final coated papers such as e.g. gloss and mottling. Furthermore, at higher addition levels, the starches would be referred to as co-binders rather than thickeners.

It is therefore apparent that there is a need in the art for coating compositions comprising improved thickeners. The present invention provides such compositions.

### SUMMARY OF THE INVENTION

In a first aspect of the present invention, there is provided a paper coating composition comprising one or more thickeners, characterised in that at least one of said one or more thickeners is a cold water swellable starch ester. Preferably, at least one of said one or more thickeners will be a starch carbamate phosphate ester derived, for example, from potato or tapioca starch.

According to one embodiment, the composition will further comprise one or more pigments, one or more binders and, optionally, one or more additives. It can be provided in dry or wet form. In its wet form, it should comprise 30-75% by weight dry substance.

According to a further aspect of the present invention, there is provided the use of a cold water swellable starch ester as a thickener in the preparation of a paper coating composition.

According to another aspect of the invention, there is provided a process for the preparation of a paper coating composition comprising adding one or more pigments, one or more thickeners, one or more binders and, optionally, one or more additives to an aqueous solution and mixing, characterised in that at least one of said one or more thickeners is a cold water swellable starch ester. Preferably, the one or more binders are added to the aqueous solution before the one or more thickeners.

According to yet another aspect of the present invention, there is provided a method of manufacturing paper comprising applying to at least one surface of a sheet of paper or a paper web a composition as defmed above or prepared according to the process described above. In one embodiment, the method will further comprise the steps of removing any excess coating composition, drying and, optionally, calendering the sheet of paper or paper web.

According to a yet further aspect of the present invention, there is provided a paper product coated with the above composition or manufactured according to the above method.

### DESCRIPTION OF THE FIGURES

FIG. 1 is a graphic representation of the Brookfield viscosity of a reference coating composition and of coating compositions comprising 0.2 parts CMC, 0.4 parts CMC, 0.6 parts CMC, 0.06 parts Noresin™ (a cold water swellable starch ester), 0.25 parts Noresin™ and 0.35 parts Noresin™ respectively.

FIG. 2 is a graphic representation of the Haake viscosity of the above listed compositions.

FIG. 3 is a graphic representation of the water retention values of the above listed compositions.

FIG. 4 represents a comparison of the influence of CMC and Noresin™ amounts on Brookfield viscosity.

FIG. 5 represents a comparison of the influence of CMC and Noresin™ amounts on Haake viscosity.

FIG. 6 represents a comparison of the influence of CMC and Noresin™ amounts on water retention values.

FIG. 7 is a graphic representation of the Brookfield viscosity of compositions comprising the compositions produced in Example 2.

FIG. 8 compares the Brookfield viscosity of fresh and stored compositions.

FIG. 9 compares the Brookfield viscosity of fresh and stored compositions.

FIG. 10 compares water retention values of fresh and stored compositions.

FIG. 11 shows the influence of stirring time on Brookfield viscosity.

FIG. 12 shows the influence of thickener type on torque.

FIG. 13 shows the influence of thickener dry solids content on Brookfield viscosity.

### DETAILED DESCRIPTION

The present invention provides a paper coating composition comprising one or more thickeners, characterised in that at least one of said one or more thickeners is a cold water swellable starch ester. A cold water swellable (or “cold water swelling”) starch ester is a starch ester, substantially all of the granules of which swell in cold water to give a viscous, colloidal dispersion. A swollen starch granule is one whose size (observable e.g. by microscopy) has at least doubled through absorption of water. Cold water will be understood to be water having a temperature of less than 50° C., preferably between 5 and 40° C., more preferably between 10 and 35° C., even more preferably between 15 and 35° C.

In a preferred embodiment of the present invention, the cold water swellable starch ester will be a starch carbamate phosphate ester. It can be derived from any type of starch including, for example, potato, maize, wheat, rice, tapioca, sorghum and sago. Preferably, however, it will be derived from potato or tapioca starch.

According to one embodiment of the present invention, the starch ester will be prepared by heating a mix of starch, acid, urea, salt and water at low pressure. As noted above, the starch will preferably be potato or tapioca derived starch. The acid will ideally be a mineral acid such as phosphoric or sulphuric acid and the salt will ideally be an alkaline salt such as an ammonium salt or soda. For 100 parts starch, the initial mix should contain 0.02-100 parts each of acid, urea, salt and water. Preferably, for 100 parts starch, the mix will contain 2.5-40 parts of both acid and urea and 0.05-40 parts of both salt and water. Ideally, for 100 parts starch, the mix should contain approximately 10 parts of both acid and urea and approximately 5 parts of both salt and water. The mix should be heated for up to 24 hours at a temperature of 80-220° C. For best results, the mix should be heated for 2-5 hours at 120-160° C. The heating should preferably be carried out at a pressure between 0.001 and 0.8 bar. More preferably, it should be carried out at a pressure between 0.1 and 0.2 bar. Starch esters prepared in this way have been found to impart surprisingly good viscosity profiles when used as thickeners in paper coating compositions.

In particular, it has surprisingly been found that coating compositions comprising even only small amounts of such thickeners have high (low shear) Brookfield viscosities (e.g. 400-2000 mpa·s) and low high shear) Haake viscosities (e.g. 10-25 mPa·s). What is more, unlike with conventional thickeners, the viscosities of these compositions are very stable, even after overnight storage.

Thus, according to a preferred embodiment, cold water swellable starch esters will be the only thickeners used in the coating compositions of the present invention. Nonetheless, if desired, one or more other thickeners may also be used. Preferably, they will be selected amongst cold water soluble and/or cold water swellable compounds including, but are not limited to, cellulose ethers (such as CMC, hydroxyethyl cellulose, hydroxypropyl cellulose, ethylhydroxyethyl cellulose and methyl cellulose), alginates (such as sodium alginate), xanthan, carrageenans, galactomannans (such as guar), native or modified starches (such as roll-dried starch) and synthetic polymers (such as polyacrylates).

In any event, the one or more cold water swellable starch esters of the present invention should account for at least 50% of total thickener content on a dry weight basis and for 0.005-2%, preferably 0.008-1.7%, even more preferably 0.01-1.5% of the dry weight of the overall coating composition. It has indeed been found that, compared to conventional thickeners, much smaller amounts of cold water swellable starch ester are needed to achieve the necessary rheological properties for a good coating composition. As a result, the coating compositions of the present invention will be considerably cheaper to produce than more conventional ones.

The coating compositions of the present invention should, of course, further comprise one or more pigments, one or more binders and, optionally, one or more additives. The pigments, binders and optional additive compounds can be selected amongst those available in the art and in accordance with the type of coating composition to be obtained.

Examples of pigments, both natural and synthetic, include: clays such as structured and calcined clays, hydrated aluminosilicates (such as kaolin clay), natural and synthetic calcium carbonate, calcium sulphate, silicas, precipitated silicas, titanium dioxide, alumina, aluminium trihydrate, plastic (polystyrene) pigments, satin white, talc, barium sulphate and zinc oxide. Preferably, the coating composition according to the present invention will comprise pigment in an amount of approximately 30 to 99%, preferably 45 to 96% by weight of the dry solids.

Examples of binders suitable for use in the composition of the present invention include: carbohydrate-based binders including starch-based binders (such as oxidised or esterified starch) and cellulose binders (such as CMC and hydroxyethyl cellulose), protein binders (such as casein, gelatine, soy protein and animal glues) and synthetic binders, especially latex binders (such as copolymer latexes, acrylic polymer latexes, vinyl polymer latexes) and synthetic resin binders. Preferably, the binder will selected such that it is different from any of the one or more thickeners being used and will be added to the coating composition in an amount of 0.5-50%, more preferably 1-35% by dry weight.

Of course, the choice of pigment and/or binder and the amounts to be used will be determined in accordance with the desired properties of the coating composition being produced.

The properties of the final coating composition can be further modified or enhanced by the use of optional additives. Examples of such additives include: surfactants (e.g. cationic surfactants, anionic surfactants, non-ionic surfactants, amphoteric surfactants and fluorinated surfactants), hardeners (e.g. active halogen compounds, vinylsulfone compounds, epoxy compounds, etc.), dispersing agents (e.g. polyacrylates, polyphosphates, polycarboxylates, etc.), flowability improvers, lubricants (e.g. calcium, ammonium and zinc stearate, wax or wax emulsions, alkyl ketene dimer, glycols, etc.), antifoamers (e.g. octyl alcohol, silicone-based antifoamers, etc.), releasing agents, foaming agents, penetrants, optical brighteners (e.g. fluorescent whiteners), preservatives (e.g. benzisothiazolone and isothiazolone compounds), biocides (e.g. metaborate, thiocyanate, sodium benzonate, etc.), yellowing inhibitors (e.g. sodium hydroxymethyl sulfonate, sodium p-toluenesulfonate, etc.), ultraviolet absorbers (e.g. benzotriazole compounds having a hydroxy-dialkylphenyl group at the 2 position), antioxidants (e.g. sterically hindered phenol compounds), insolubilisers, antistatic agents, pH regulators (e.g. sodium hydroxide, sulfuric acid, hydrochloric acid, etc.), water-resisting agents (e.g. ketone resin, anionic latex, glyoxal, etc.), wet and/or dry strengthening agents (e.g. glyoxal based resins, oxidised polyethylenes, melamine resins, urea formaldehyde, etc.) gloss-ink holdout additives, grease and oil resistance additives, leveling and evening aids (e.g. polyethylene emulsions, alcohol/ethylene oxide, etc.), etc.

The amount of each of these compounds to be added, if at all, will be determined in accordance with standard practice and with the desired properties of the coating composition to be produced in mind. The composition can be provided in dry form or in an aqueous solution. The aqueous solution should have a total content of 30-75% by weight dry substance. The remaining 25-70% will consist essentially of water and/or other suitable fluids such as solvents. If used, solvents will preferably be selected amongst hydrophilic organic solvents such as methanol. Ideally however, water alone will be used.

The paper coating composition in accordance with the present invention can be prepared simply by mixing the above ingredients (namely one or more pigments, one or more thickeners (at least one of which is a cold water swellable starch ester), one or more binders and, optionally, one or more additives) into the aqueous solution. Thus, the present invention further provides a process for the preparation of a paper coating composition and the use of a cold water swellable starch ester in such a process.

As pigments are generally the ingredient present in the largest amount, amounts of all other ingredients to be mixed into the aqueous solution can conveniently be expressed as parts per 100 parts pigment. Thus, for 100 parts pigment, 0.01-2, preferably 0.1-1 parts cold water swellable starch ester and 1 to 50, preferably 5 to 25 parts binder will be added to the aqueous solution. The ingredients can be mixed in any order or simultaneously. The cold water swellable starch ester can also be dissolved separately in water (preferably at 1-10% dry substance, more preferably at about 5% dry substance) and added to the composition as a viscous solution. For more moderate thickening, the one or more cold water swellable starch esters (whether pre-dissolved or not) can be added to the composition after the one or more binders. The ingredients should be mixed for a sufficient time to form a substantially homogeneous slurry.

The coating composition thus prepared can either be stored or it can be applied directly to paper. Thus, the present invention further provides a method of manufacturing paper products comprising applying to at least one surface of a sheet of paper or paper web a composition as defined herein.

The terms “paper” and “paper product” refer to sheet material of any thickness, including, for example, paper board, cardboard and corrugated board. The term “paper web”, by contrast, refers to the continuous ribbon of paper, in its full width, at any stage during the paper making process.

Coating of the paper products can be carried out on the sheet forming machine or on a separate coating machine. Methods of applying coating compositions to paper products are well known in the art. They include, for example, air knife coating, rod coating, bar coating, wire bar coating, spray coating, brush coating, cast coating, flexible blade coating, gravure coating, jet applicator coating, extrusion coating, short dwell coating, slide hopper coating, curtain coating, flexographic coating, size-press coating, gate roll coating, reverse roll coating and transfer roll coating. According to the quality of paper desired, it can be coated only once or a plurality of times, provided that at least one of the coatings is in accordance with the present invention. If more than one coating is to be applied, both surfaces of the paper web can be coated.

After the coating step, excess coating composition can be removed. The paper is then dried and optionally calendered to improve surface smoothness and gloss and to reduce bulk. Drying methods include, but are not limited to, air or convection drying (e.g. linear tunnel drying, arc drying, air-loop drying, sine curve air float drying, etc.), contact or conduction drying and radiant energy drying (e.g. infrared or microwave drying). Calendering is achieved by passing the coated paper between calender nips or rollers (preferably elastomer coated nips or rollers) one or more times. For best results, calendering should be carried out at elevated temperatures. Ideally for each coating step, a dry coating weight in the range from about 4 to about 30 g/M², preferably from about 6 to about 20 g/m² will be achieved, with a coating thickness of 1-50 μm.

Advantageously, it has been found that use of the coating composition of the present invention leads to smoother, higher gloss paper products with improved optical properties such as opacity and whiteness and improved printing properties such as printing gloss. Accordingly, paper products coated with the above described composition or indeed obtained according to the above described method also form part of the present invention which will now be described in more detail by way of the following non-limiting examples.

### EXAMPLES

### Example 1

### Comparison of the Properties of CMC and a Cold Water Swellable (cws) Starch Ester According to the Invention

A series of tests with 0.2, 0.4 and 0.6 parts CMC FF5 (from Noviant) were performed—parts expressed per 100 parts pigment. The amount of Noresin™ A 180 (a cold water swellable starch carbamate phosphate ester available from Blattmann Cerestar AG) required, in each case, to reach the same Brookfield viscosity was then determined.

CMC and Noresin™ Preparation:

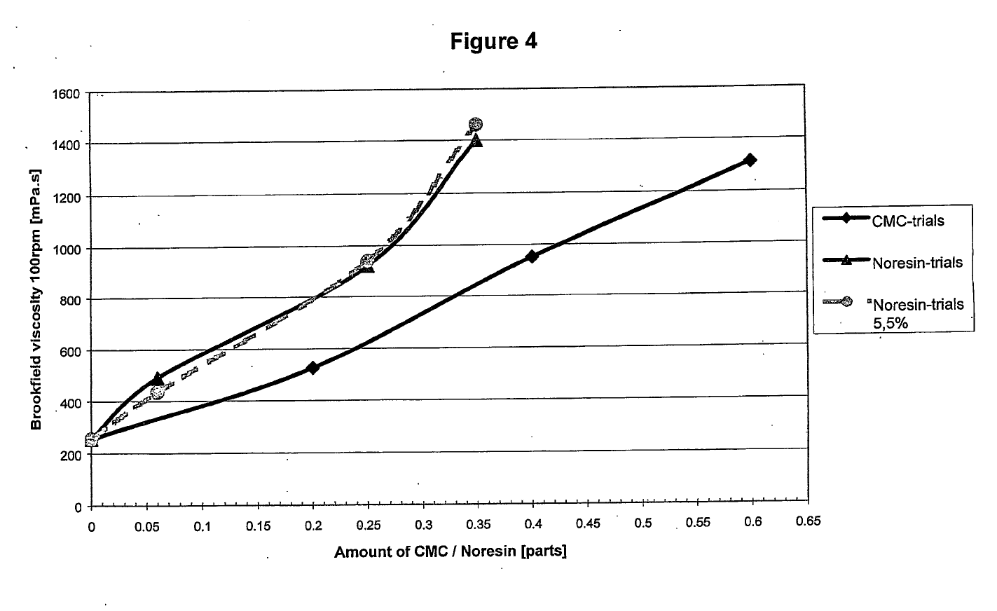

CMC and Noresin™ were added to tap water at about 40° C. and homogenised with a Type LD50 dissolver (Pendraulik GmbH) for 30 minutes. The CMC was prepared at 15.1% dry solids and the Noresin™ at 9.4% and 5.5% dry solids, respectively. Brookfield viscosity was then determined at 50° C. and 100 rpm (with a Brookfield RVF viscometer). Results are shown in Table 1 and FIG. 4.

TABLE 1

| Viscosity data for: | CMC | Noresin ™ | |
|---|---|---|---|
| Dry solids (%) | 15.1 | 9.4 | 5.5 |
| pH | 5.4 | 7.2 | 7.2 |
| Brookfield viscosity 100 rpm at 50° C. | 4050 | 9850 | 3120 |
| (mPa · s) | | | |

As can be seen from these results, CMC FF5, at 15.1% dry solids (d.s.), has a Brookfield viscosity of 4050 mPa·s. Lab trials showed that Noresin™, when used at 15% d.s., did not give comparable results. Even a 9.4% solution of Noresin™ reached a Brookfield viscosity of nearly 10 000 mPa·s and would therefore be too viscous to handle. Accordingly, the appropriate dry solid content of Noresin™ was determined to be 5-6% by weight (5,5% reached 3120 mPa·s).

Coating Composition Preparation:

Coating compositions were prepared by mixing the ingredients shown in Table 2 with the LD50 dissolver for 5-10 min. Dry substance levels were adjusted by adding water at room temperature.

Trials 1, 2, 3, 4a and 5a:

For these trials CMC and Noresin™ were added to the pigment slurry before the latex binder was added.

Trials 4, 5 and 6-9:

For these trials, the latex binder was added first to the pigment slurry, then Noresin™ was added.

For all trials, total dry solid content was adjusted to approximately 69% by weight and the pH was adjusted to 8.5 by addition of 50% NaOH solution.

The coating compositions were analysed according to standard industry methods with regard to Brookfield viscosity (using a Brookfield RVF viscometer) and Haake viscosity (Haake Rotovisco RT20, rotor HS 25/stator HS 28, shear rate 45000 s⁻¹). WRVs (water retention values) were measured using the Åbo Akademi GWR method.

This analysis revealed that Noresin™ was much more effective than CMC at lower addition rates. It was indeed found that, to obtain a coating composition with a Brookfield viscosity of approximately 500 mPa·s, the addition of 0.2 parts CMC was comparable to the addition of only 0.05 parts of Noresin™. To reach a coating colour having a Brookfield viscosity of ˜1400 mPa·s only 0.35 parts Noresin™ were necessary compared to 0.6 parts of CMC. Accordingly, by using cold water swellable starch esters instead of CMC, significant cost reductions can be made.

Best results (i.e. more moderate thickening) were obtained with Noresin™ when it was added to the coating composition mix after the latex binder. Thickening is further reduced by adding any remaining water and fully homogenising the mixture.

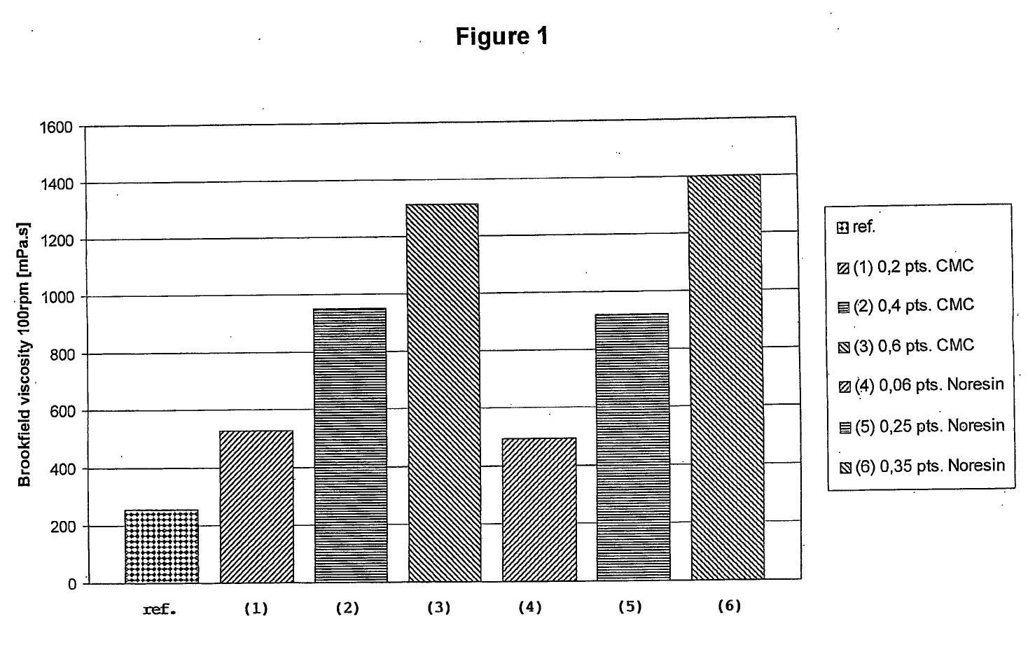

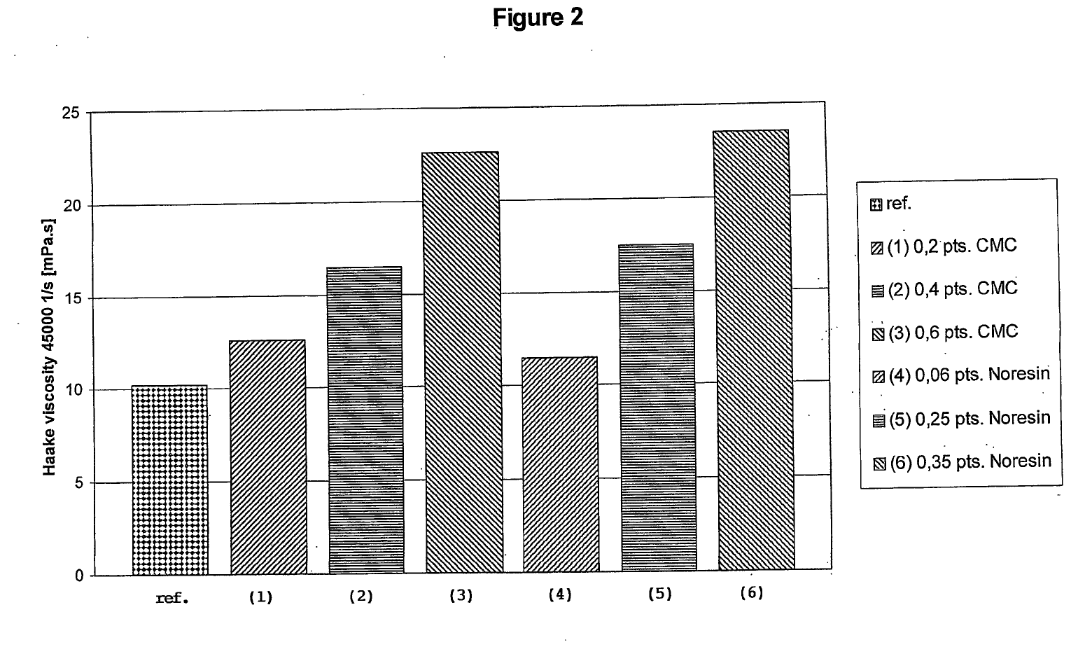

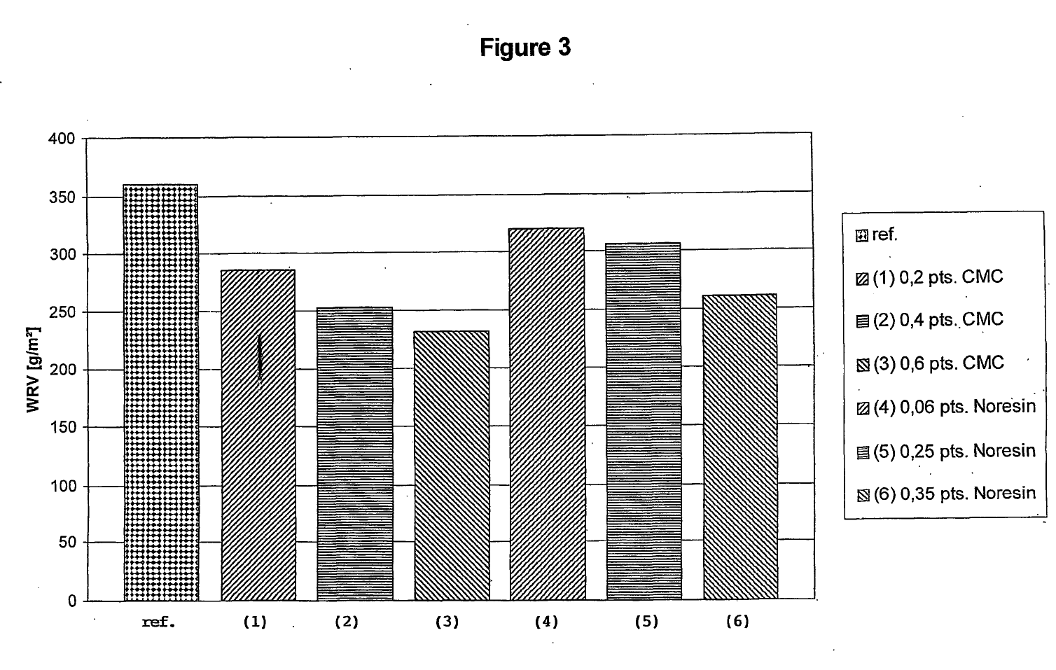

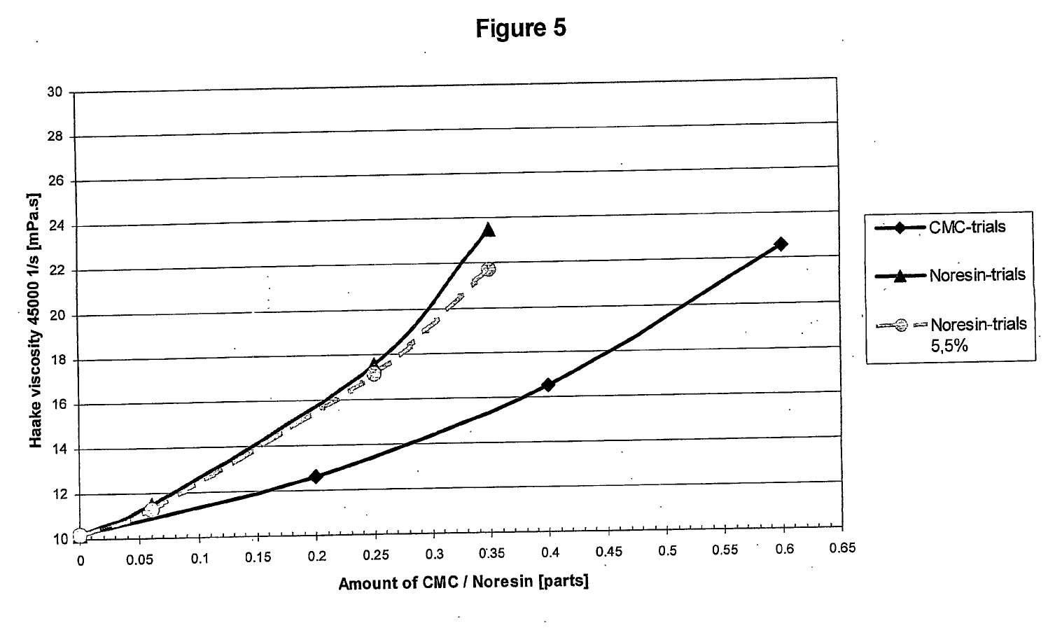

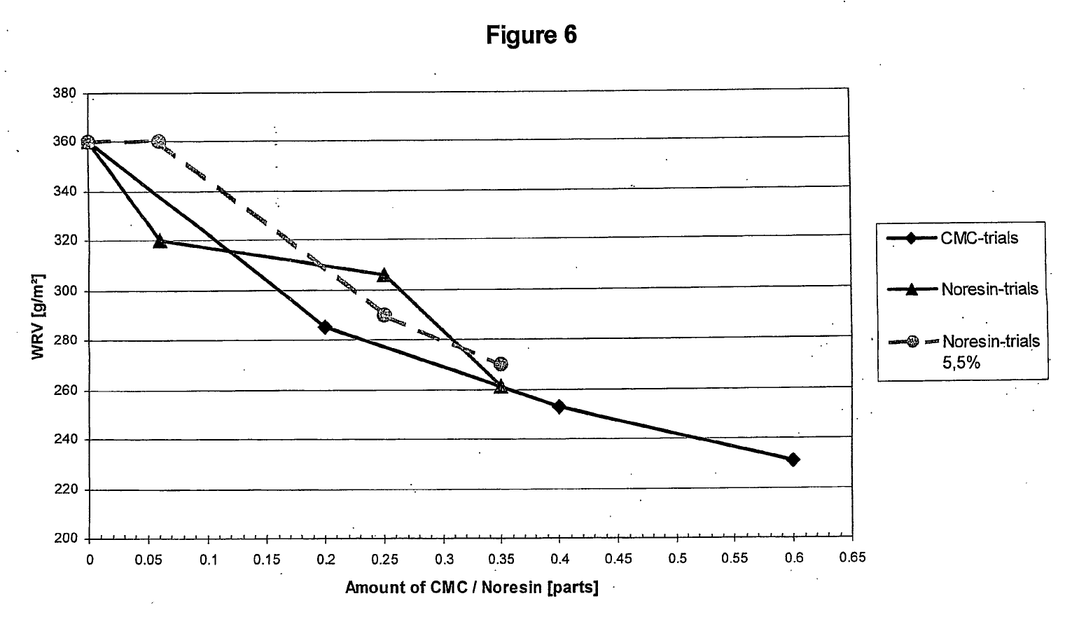

The fall results of these trials are set out in Table 2 and in FIGS. 1-6.

TABLE 2

| Trial no. | | | | | | | | | | | |
|---|---|---|---|---|---|---|---|---|---|---|---|
| ref. | 1 | 2 | 3 | 4 | 4a | 5 | 5a | 6 | 7 | 8 | 9 |

Formulation (parts)
Pigment

| | | | | | | | | | | | | |
|---|---|---|---|---|---|---|---|---|---|---|---|---|
| Hydrocarb 60 (Omya) | 100 | 100 | 100 | 100 | 100 | 100 | 100 | 100 | 100 | 100 | 100 | 100 |

Binder

| | | | | | | | | | | | | |
|---|---|---|---|---|---|---|---|---|---|---|---|---|
| Baystal P 7110 (from Bayer AG) | 12 | 12 | 12 | 12 | 12 | 12 | 12 | 12 | 12 | 12 | 12 | 12 |

Thickener

| | | | | | | | | | | | |
|---|---|---|---|---|---|---|---|---|---|---|---|
| CMC FF 5 | 0.2 | 0.4 | 0.6 | | | | | | | | |
| Noresin ™ A 180 | | | | 0.05 | 0.05 | 0.06 | 0.06 | 0.2 | 0.25 | 0.3 | 0.35 |

Coating composition data

| | | | | | | | | | | | | |
|---|---|---|---|---|---|---|---|---|---|---|---|---|
| Total Dry solids | 69.3 | 69.2 | 69.1 | 69.1 | 69.2 | 69 | 69 | 69 | 68.8 | 69 | 69.3 | 68.9 |
| pH | 8.5 | 8.5 | 8.5 | 8.5 | 8.5 | 8.6 | 8.5 | 8.5 | 8.5 | 8.5 | 8.5 | 8.5 |
| Brookfield viscosity 100 rpm | 256 | 525 | 950 | 1310 | 445 | 505 | 435 | 450 | 840 | 920 | 1130 | 1400 |
| (mPa · s) | | | | | | | | | | | | |
| Haake viscosity 45000 1/s | 10.2 | 12.6 | 16.5 | 22.6 | — | 10.9 | 11.3 | 11.3 | 15 | 17.5 | 18.5 | 23.5 |
| (mPa · s) | | | | | | | | | | | | |
| WRV (g/m²) | 360 | 285 | 253 | 231 | — | 360 | 360 | 340 | 310 | 306 | 269 | 261 |

### Example 2

### Influence of Dry Solids on Brookfield Viscosity

A number of thickener solutions were prepared as detailed in Table 3. Trials 1 and 1a used Noresin™ A 180. Trials 2 and 2a used cold water swellable native maize starch (Cerestar). Trials 3 and 3a used oxidised cold water swellable starch (Cerestar). Trials 4, 4a, 4.1 and 4.1a used CMC FF150 (Noviant). Trials 5 and 5a used a cold water swellable starch ether (Cerestar) and, finally, trial 6 used a cold water swellable hydroxypropylated, non-ionic potato starch ether (Emsland Stärke GmbH).

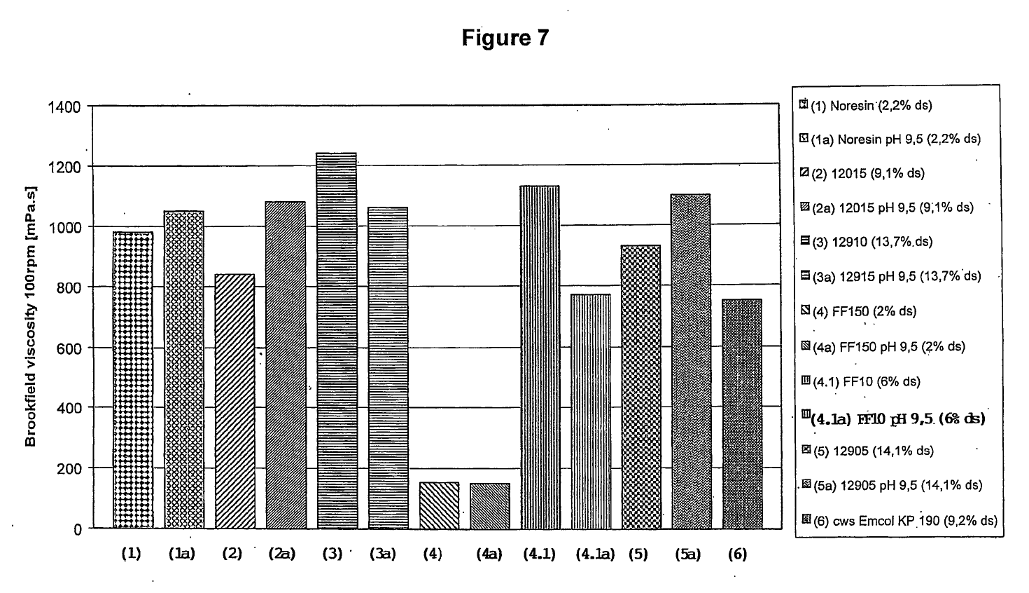

The thickener was added to tap water at 40° C. in a 2 litre metal beaker and stirred at approximately 3200 rpm for 20 minutes. The amount of thickener added was calculated based on the desired dry solid content (see Table 3). pH was adjusted to the values shown in Table 3 using 50% NaOH solution (for each thickener, a near-neutral and an alkaline pH were tested to emulate the differences in viscosity and stability when these compounds are used alone and in a coating composition). Brookfield viscosity, Haake viscosity and water retention values (WRVs) were determined using standard methods in the art (as above), both immediately after preparation of the solutions and after overnight storage at 40° C. The results are shown in Table 3 and in FIGS. 7-10.

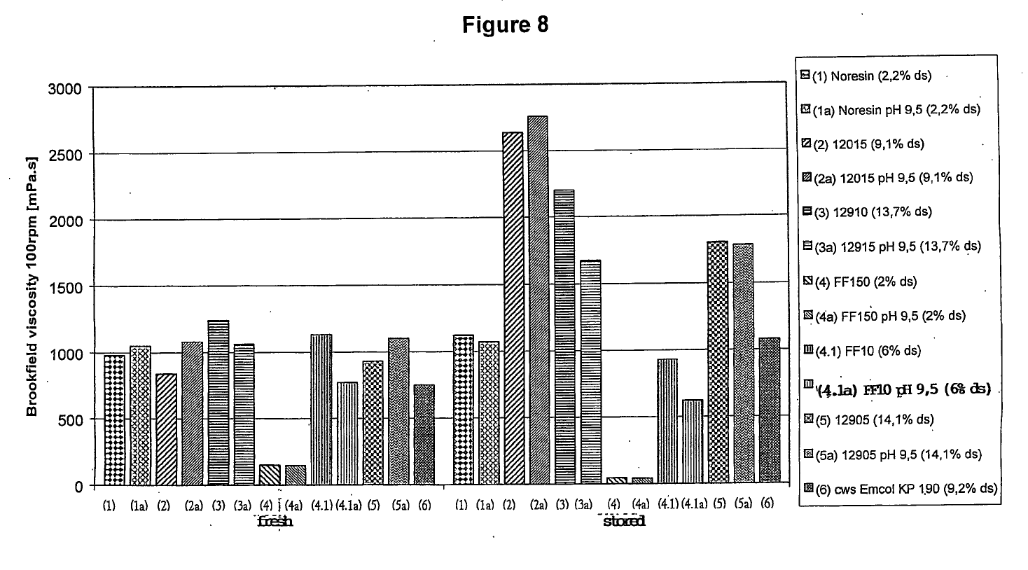

It was found that Noresin™ produced stable viscosities at varying pH and that, at 2.2% dry solids, Noresin™ produces a Brookfield viscosity which can only be obtained with CMC, for example, at 6% dry solids or with a cold water swellable starch ether at 14.1% dry solids (see FIG. 7). It was also observed that the Brookfield viscosity of Noresin™ solutions remains surprisingly stable during storage, while the viscosity of solutions prepared with cws native maize starch, for example, more than doubles (see FIG. 8).

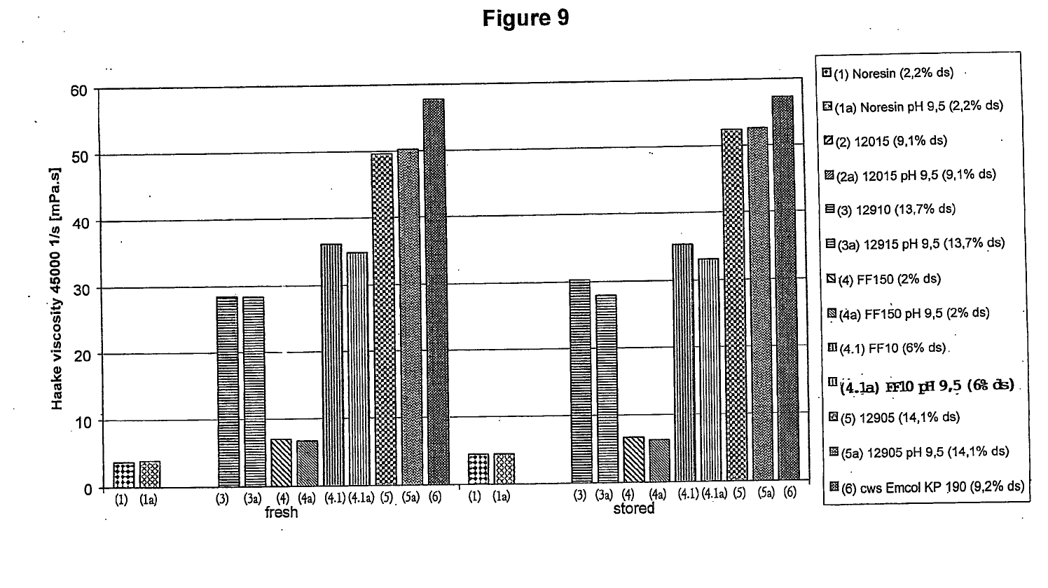

As shown in FIG. 9, the Haake viscosity of Noresin™ solutions was desirably lower than that of solutions prepared with alternative thickeners. Again, the Haake viscosity of Noresin™ solutions was found to be stable during storage.

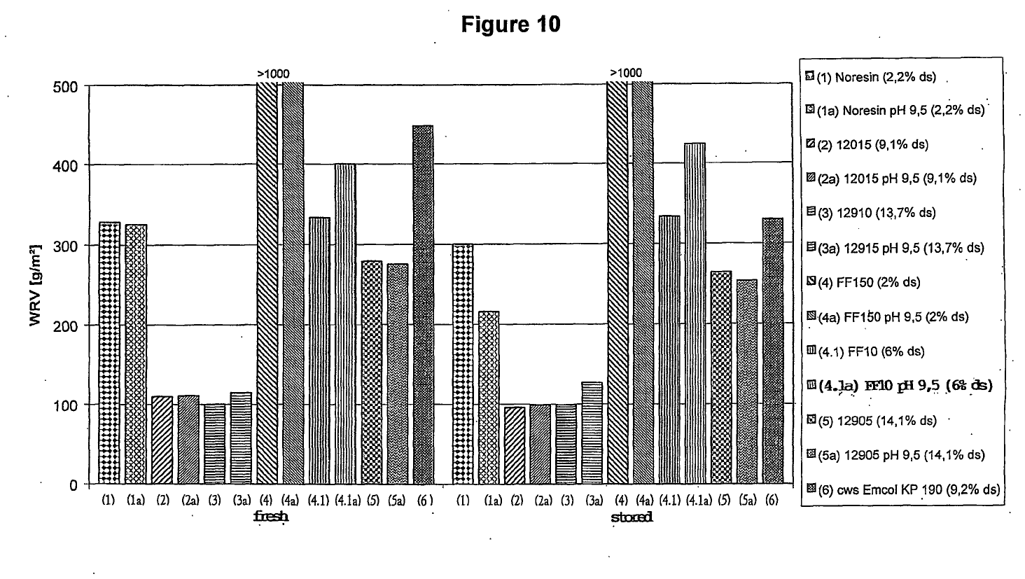

Water retention values of Noresin™ solutions were found to be suitable for use in coating compositions and stable over time (FIG. 10). In particular, it was found that the water retention values of Noresin solutions were desirably lower than those of CMC solutions at comparable dry substance.

TABLE 3

| Trial | | | | | | | | | | | | |
|---|---|---|---|---|---|---|---|---|---|---|---|---|
| 1 | 1a | 2 | 2a | 3 | 3a | 4 | 4a | 4.1 | 4.1a | 5 | 5a | 6 |

Thickener (parts)

| | | | | | | | | | | | | | |
|---|---|---|---|---|---|---|---|---|---|---|---|---|---|
| Noresin ™ A 180 | 100 | 100 | | | | | | | | | | | |
| cws native maize starch | | | 100 | 100 | | | | | | | | | |
| C*Plus 12015 | | | | | | | | | | | | | |
| cws oxidised maize starch | | | | | 100 | 100 | | | | | | | |
| C*Plus 12910 | | | | | | | | | | | | | |
| CMC FF150 | | | | | | | 100 | 100 | 100 | 100 | | | |
| cws maize starch ether | | | | | | | | | | | 100 | 100 | |
| C*Film 12905 | | | | | | | | | | | | | |
| cws potato starch ether | | | | | | | | | | | | | 100 |
| Emcol KP 190 | | | | | | | | | | | | | |

Solution data

| | | | | | | | | | | | | | |
|---|---|---|---|---|---|---|---|---|---|---|---|---|---|
| dry solids | 2.2 | 2.2 | 9.1 | 9.1 | 13.7 | 13.7 | 2.0 | 2.0 | 6.0 | 6.0 | 14.1 | 14.1 | 9.2 |
| pH | 7.5 | 9.5 | 7.9 | 9.5 | 7.9 | 9.5 | 7.7 | 9.4 | 6.6 | 9.6 | 7.6 | 9.5 | 10.7 |
| Brookfield viscosity | 980 | 1050 | 840 | 1080 | 1240 | 1060 | 153 | 149 | 1130 | 770 | 930 | 1100 | 750 |
| 100 rpm (mPa · s) | | | | | | | | | | | | | |
| Haake viscosity 45000 1/s | 3.7 | 3.9 | — | — | 28.5 | 28.4 | 7 | 6.7 | 36.1 | 34.8 | 49.6 | 50.2 | 57.7 |
| (mPa · s) | | | | | | | | | | | | | |
| WRV (g/m²) | 328 | 325 | 110 | 111 | 100 | 115 | >1000 | >1000 | 333 | 400 | 279 | 275 | 448 |

Solution data after storage overnight @ 40° C., 50 rpm

| | | | | | | | | | | | | | |
|---|---|---|---|---|---|---|---|---|---|---|---|---|---|
| dry solids | 2.2 | 2.2 | 9.1 | 9.1 | 13.7 | 13.7 | 2.1 | 2.1 | 6 | 6 | 14.2 | 14.2 | 9.4 |
| pH | 7.9 | 9.4 | 7.4 | 8.9 | 7.5 | 8.7 | 8.4 | 8.8 | 6.8 | 7.9 | 8.2 | 9.5 | 10.5 |
| Brookfield viscosity | 1120 | 1070 | 2640 | 2760 | 2200 | 1670 | 47.5 | 43.5 | 930 | 620 | 1800 | 1780 | 1080 |
| 100 rpm (mPa · s) | | | | | | | | | | | | | |
| Haake viscosity 45000 1/s | 4.5 | 4.5 | — | — | 30.3 | 27.9 | 6.7 | 6.3 | 35.3 | 33 | 52.4 | 52.6 | 57.2 |
| (mPa · s) | | | | | | | | | | | | | |
| WRV (g/m²) | 300 | 216 | 96 | 99 | 99 | 127 | >1000 | >1000 | 333 | 424 | 264 | 253 | 329 |

### Example 3

### Influence of Stirring Time on Brookfield Viscosity

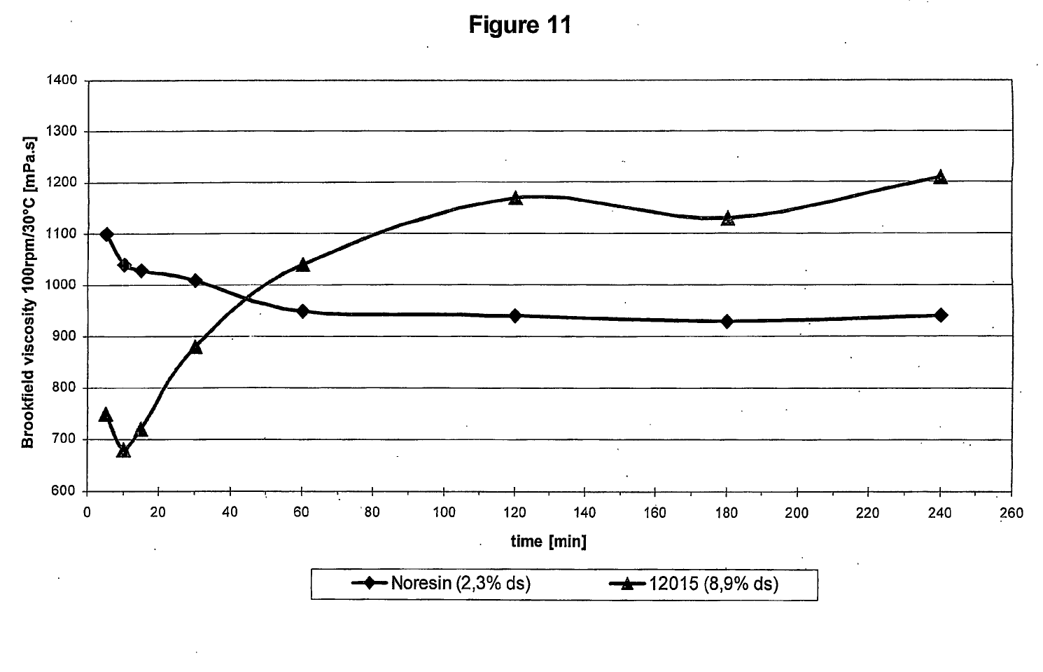

Noresin™ and cws native maize starch solutions were prepared by adding 2.3% dry substance and 8.9% dry substance, respectively, to tap water at 40° C. in a 1 litre metal beaker. The solutions were then mixed at 3200 rpm for 20 minutes. Brookfield viscosity was measured using standard methods (as above). The results are set out in Table 4 and in FIG. 11.

TABLE 4

| | |
|---|---|
| | C*Plus 12015 |
| Noresin ™ (2.3% ds) | (8.9% ds) |

| | |
|---|---|
| Time (min) | Brookfield viscosity 100 rpm/30° C. (mPa · s) |

| | | |
|---|---|---|
| 5 | 1100 | 750 |
| 10 | 1040 | 680 |
| 15 | 1030 | 720 |
| 30 | 1010 | 880 |
| 60 | 950 | 1040 |
| 120 | 940 | 1170 |
| 180 | 930 | 1130 |
| 240 | 940 | 1210 |

As can bee seen from these results, the Brookfield viscosity of Noresin™ solutions is surprisingly stable compared to that of conventional thickeners.

### Example 4

### Influence of Thickener on Torque

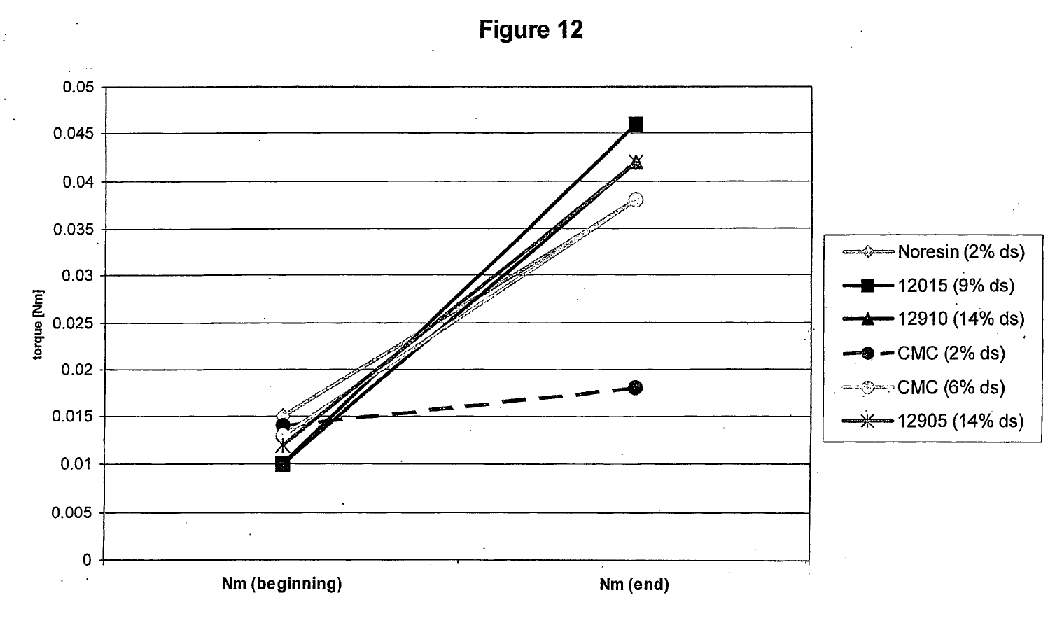

Thickener solutions were prepared in 1 litre metal beakers. The thickeners used and the dry solid content of each solution is indicated in Table 5. The solutions were stirred (with an IKA propeller stirrer, MR-AO.2) at 1500 rpm until a stable curve was obtained. Torque was then measured (with a torque measurement unit from IKA-Janke & Kunkel, RE-162) using standard methods. Beginning and end values were recorded. The results are set out in Table 5 and in FIG. 12.

It was found that Noresin™ at low dry substance (2% ds) had similar torque values (i.e. shear resistance) to other thickeners at much higher dry substance. When these more conventional thickeners were used at low dry substance, it was found that their torque values dropped substantially (in Table 5, CMC is illustrated at 2% d.s.).

TABLE 5

| | Noresin ™ | C*Plus 12015 | C*Plus 12910 | CMC FF150 | CMC FF150 | C*Plus 12905 |
|---|---|---|---|---|---|---|
| | (2% ds) | (9% ds) | (14% ds) | (2% ds) | (6% ds) | (14% ds) |
| Nm (beginning) | 0.015 | 0.01 | 0.01 | 0.014 | 0.013 | 0.012 |
| Nm (end) | 0.038 | 0.046 | 0.042 | 0.018 | 0.038 | 0.042 |

### Example 5

### Influence of Dry Solids on Brookfield Viscosity

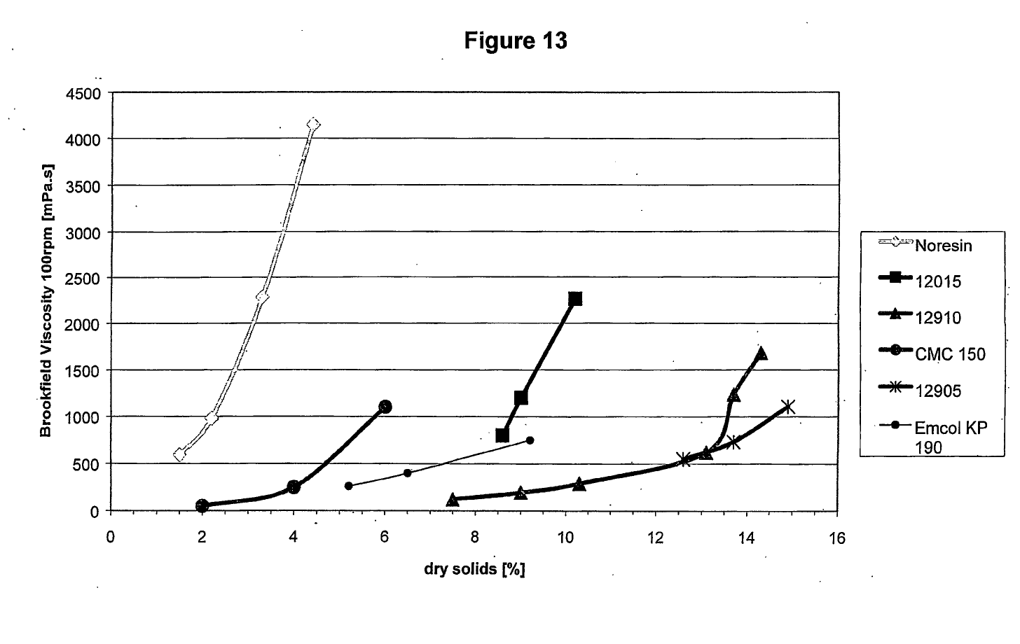

Solutions of thickener were prepared as described in Example 2. Brookfield viscosity (at 100 rpm and 30 ° C.) was measured at several different dry solid contents for each thickener. The results are set out in Table 6 and in FIG. 13.

TABLE 6
Noresin ™

| | | | | |
|---|---|---|---|---|
| ds (%) | 1.5 | 2.2 | 3.3 | 4.4 |
| Brookf (mPa · s) | 590 | 980 | 2280 | 4150 |

C*Plus 12015

| | | | |
|---|---|---|---|
| ds (%) | 8.6 | 9 | 10.2 |
| Brookf (mPa · s) | 800 | 1200 | 2260 |

C*Plus 12910

| | | | | | | |
|---|---|---|---|---|---|---|
| ds (%) | 7.5 | 9 | 10.3 | 13.1 | 13.7 | 14.3 |
| Brookf (mPa · s) | 122 | 194 | 290 | 620 | 1240 | 1680 |

CMC FF150

| | | | |
|---|---|---|---|
| ds (%) | 2 | 4 | 6 |
| Brookf (mPa · s) | 50 | 250 | 1100 |

C*Film 12905

| | | | |
|---|---|---|---|
| ds (%) | 12.6 | 13.7 | 14.9 |
| Brookf (mPa · s) | 550 | 735 | 1110 |

Emcol KP 190

| | | | |
|---|---|---|---|
| ds (%) | 5.2 | 6.5 | 9.2 |
| Brookf (mPa · s) | 260 | 400 | 750 |

These results confirm that high Brookfield viscosities can be obtained with relatively low amounts of Noresin™ compared to conventional thickeners.

1. A paper coating composition comprising one or more thickeners, characterised in that at least one of said one or more thickeners is a cold water swellable starch ester.

2. A paper coating composition according to claim 1, characterised in that the starch ester is a starch carbamate phosphate ester.

3. A paper coating composition according to claim 1, characterised in that the starch ester is derived from potato or tapioca starch.

4. A paper coating composition according to claim 1, characterised in that it comprises 0.005-2% by dry weight of said starch ester.

5. A paper coating composition according to claim 1, characterised in that the composition further comprises one or more pigments, one or more binders and, optionally, one or more additives.

6. A paper coating composition according to claim 1, characterised in that the composition comprises 30-75% by weight dry substance.

7. (canceled)

8. A process for the preparation of a paper coating composition comprising adding one or more pigments, one or more thickeners, one or more binders and, optionally, one or more additives to an aqueous solution and mixing the solution, characterised in that at least one of said one or more thickeners is a cold water swellable starch ester.

9. A process according to claim 8 characterised in that the one or more binders are added to the aqueous solution before the one or more thickeners.

10. A process according to of claim 8 characterised in that, for 100 parts pigment, the composition comprises 0.01-2 parts starch ester.

11. A method of manufacturing paper comprising applying to at least one surface of a sheet of paper or a paper web a composition according to claim 1 or prepared according to the process of claim 8.

12. A method according to claim 11, further comprising the steps of removing any excess coating composition, drying and, optionally, calendering the sheet of paper or paper web.

13. A paper product coated with a composition according to claim 1 or manufactured according to the method of claim 11.

14. A paper coating composition according to claim 1, characterised in that it comprises 0.008-1.7% by dry weight of said starch ester.
